(19) United States
(12) Patent Application Publication
(10) Pub. No.: US 2025/0059719 A1
(43) Pub. Date: Feb. 20, 2025

(54) Algal Wave Guide

(71) Applicant: William Izaac Wold, Fayetteville, NC (US)

(72) Inventor: William Izaac Wold, Fayetteville, NC (US)

(21) Appl. No.: 18/416,987

(22) Filed: Jan. 19, 2024

Related U.S. Application Data
(63) Continuation of application No. 63/532,776, filed on Aug. 15, 2023.

(51) Int. Cl. A01G 33/00; A01M 29/30

(52) U.S. Cl. CPC A01G 33/00; A01M 29/30; G02B 6/0008

(57) ABSTRACT

The present invention pertains to optical wave guides (ie structures that guide waves by restricting the transmission of energy to one direction) buoys, anchors, and climate change. The Algal Wave Guide directs energy to Algae in maritime and lake environments in order to expand the viable range of highly productive carbon sequestering environments such as the Brown Algae among others. Sequestering carbon at sea has several advantages over terrestrial methods such as lower cost, surface availability compared to land based real estate, reduced infrastructure, increased fishery quotas, commercial chemical and lubricant production, tourism, fertilizer inputs, etc.

### CROSS-REFERENCE TO RELATED APPLICATIONS

This patent application claims the priority of pending provisional patent application No. 63/532,776 filed on 15 Aug. 2023.

### BACKGROUND OF THE INVENTION

The purpose of the Algal Wave Guide is to extend the viable depth of Kelp forests which are critical environments supporting fisheries, chemical/research industries, and carbon sequestration. This invention is essential to mitigating and adapting to global warming. However, additional kelp specific economic applications are extensive. The commercial use of products derived from Kelp forests can be traced back to the stone age era given concentrations of abalone, limpets and mussel shells, at archaeological sites. Modern Kelp applications follow: 1) kelp is often used to obtain iodine (preventing goiter) 2) sodium bicarbonate can be obtained from kelp (cleaning agent, and additive to glass or paper) 3) alginate is used as a filler in substances as varied as ice cream, jelly, toothpaste, dog food 4) food stuffs such as garnish, salad, seasoning. 5) the concentration of potassium in kelp is a resource for fertilizer and chemical industries. 6) table salt. 7) associated organisms that are harvested from the kelp forest environment are rockfish, sea urchin, snails, etc. 8) carbon sequestration

Carbon sequestration is the concept of capturing gaseous Carbon Dioxide (CO²) and turning the Carbon into solid forms. Carbon Dioxide is a biproduct of internal combustion engines, steam engines, jet engines, etc that is released into the atmosphere. Carbon Dioxide levels in the atmosphere have risen by 50% since the industrial era. Given that Carbon Dioxide absorbs sunlight and heats to a greater extent than other atmospheric compounds temperatures on Earth are rising. Without refrigeration temperatures above 90° F. wetbulb (ie. 100% humidity) are lethal to humans in prolonged settings. Occurrences of these temperatures have steadily risen in recent years but are mitigated by modern necessities such as HVAC systems, ice machines, vehicle based air conditioning. However, use of modern refrigeration requires consumption of additional fossil fuels contributing more Carbon Dioxide. Furthermore, it is infeasible to simply reduce consumption of fossil fuels given modern agribusiness, which is essential to sustaining a large human population, is dependent upon large quantities of diesel and natural gas (two of the numerous fossil fuels which produce greenhouse gases when used). What is now needed is an efficient mechanism of converting Carbon Dioxide into solid organic compounds such as biomass, without requiring additional electric energy. If this problem is not resolved humanity faces an extinction level threat. Carbon sequestration is a viable business model given currently operational compliance markets in the EU, UK, California, New Zealand, South Korea, and China.

Algal life forms are one of two biological Kingdoms (Bacteria and Protista, latter including Algae) having the potential for exponential growth rates, thus capable of mitigating climate change. In the case of Protista this includes photosynthetic organisms capable of fixing gaseous carbon dioxide into organic compounds for return to the seafloor, thus sequestering a dangerous greenhouse gas, if sufficient light is provided. This invention combines optical products in a novel organization, for the purpose of modifying the seafloor habitat, in order to cause algal species to expand. Expansion of brown algae will consequently reduce ocean dissolved carbon dioxide (which is causing ocean acidification and reef die offs) and atmospheric carbon dioxide levels. This approach has great efficiency advantages compared to all other known chemical, electro, mechanical methods and may open a path for continued use of fossil fuels if deployed at large enough scales. Furthermore, it would expand diverse ecosystems and increase biomass ratio to volume in deeper regions of the ocean.

### SUMMARY OF THE INVENTION

The invention provides a system of optical components mounted on a buoy of toroidal shape in order to provide floatation and durability in maritime environments. By suspending a solid glass hemisphere on the surface of a natural waterbody, it is possible to change the measure of refractivity at the surface. This in turn proves that maritime seafloor environments may be modified to increase the growth of biomass reducing gaseous carbon dioxide and mitigating climate change. Species of Macrocystis (a family of brown algae) have been measured at peak levels of growth of 3 kilograms per day. This is one of the highest growth rates of any organisms, not requiring infrastructure, and implies megaton biomass productivity if deployed at the square kilometer size. Given the immense size requirements for biomass fixation, the only viable terrain are the Oceans and thus the system must be optimized for harsh maritime conditions including wave action, UV radiation, and high winds.

The lens is the key component to the algal wave guide. The lens provides a focal point in which to suspend the fiberoptic cable which terminates 10 to 100 centimeters above the sporophyte or growing macroalgae on the sea floor. Not all wave guides require fiberoptic line. In shallower applications the light from the lens will be sufficient to spur algal growth (to include varieties other than brown algae, but which are again fixed to the sea floor or substrates). For deeper applications, the systems is anchored by a sprorphyte seeded rock with the proper density for lying above the seafloor, which may include mud or sand (incompatible substrates for macroalgae growth).

In total this system includes no moving parts or electronics although later models may include light emitting diodes proximate to the fiber for increased photon transmission. In operation, following the anchor and growth phases, the system will be relocated. Upon sufficient growth for the organism to achieve photosynthetic independence from its parent algal wave guide the fiber and buoy will be transferred to another seeded anchor, planted and thus the range of existing kelp beds will be extended to deeper water until atmospheric carbon dioxide levels are corrected to the level directed by governing bodies.

Minimum light energy levels of 1 umol photons (micro mol; 6.0223×10²³) per meter square per second have been sufficient to sustain growth of Laminariales sporophytes on all species studied in Effect of photon irradiance and photoperiod on young sporophytes of fur species of the Laminareiales by Taejun Han and Joanna M Kain 9 Jun. 1994. This low energy level is in turn sustainable by 1 mm fiber optic cable (assuming it is maintained within a centimeter of the target sporophyte) and would be greatly enhanced by centimeter diameter fiberoptic cable. Sufficient light transmission was measured even with lengths of fiber measuring 1.5 kilometers. This in turn implies a much greater range of depth for macroalgae which are typically limited to no greater depth than 40 meters due to refraction, occlusion, and absorption in naturally occurring water columns. Given the infinitesimally small energy requirement of Laminarea and Macrocystis sporophytes, this in turn indicates that range of macroalgae environment may be greatly expanded, even beyond the range necessitated by carbon dioxide conversion.

### BRIEF DESCRIPTION OF DRAWINGS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

FIG. 1 is a detailed perspective of the Algal Wave Guide prototype. It includes several components providing securement within the lake or maritime environment. Other components are for flotation in order that the lens is situated between water and air, a lens providing higher refractivity than the naturally occurring water surface, fiberoptic cable in order to transport light beyond the natural optical attenuation of a body of water. The lens may be fitted within the buoy and dispensing with the harness. Additionally, the chemistry of the glass may be modified for increased refractivity.

FIG. 2 depicts the planned installation of algal wave guides at sea or in other aquatic environments.

### DETAILED DESCRIPTION OF THE INVENTION

Descriptive embodiments are now explained. Other embodiments may be used in addition or instead. Details that may be apparent or unnecessary may be omitted to save space or for more effective presentation. Some embodiments may be practiced with additional components or steps and/or without all components or steps described.

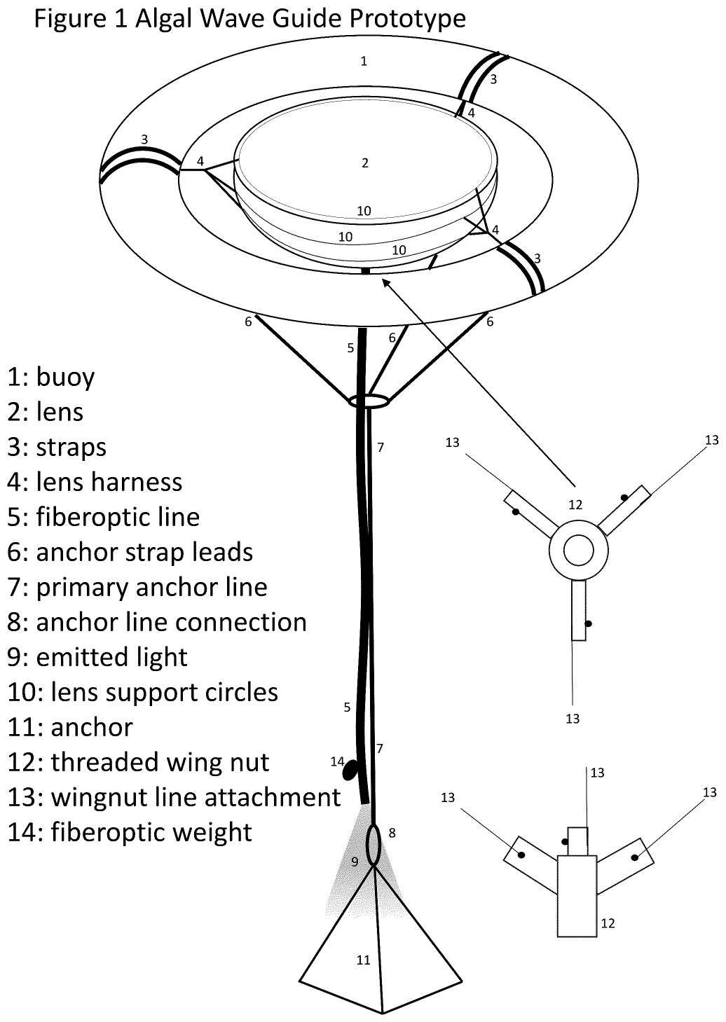

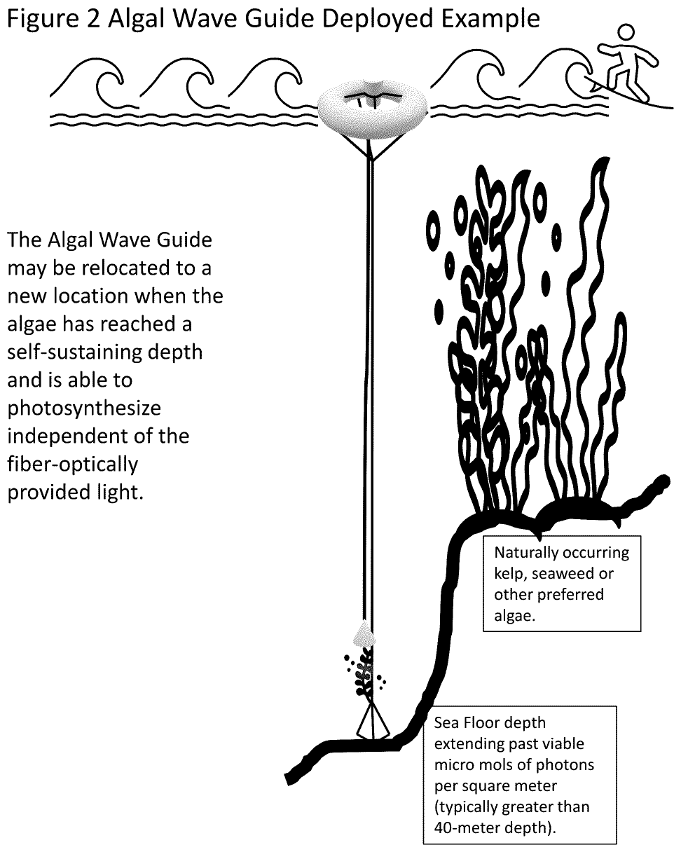

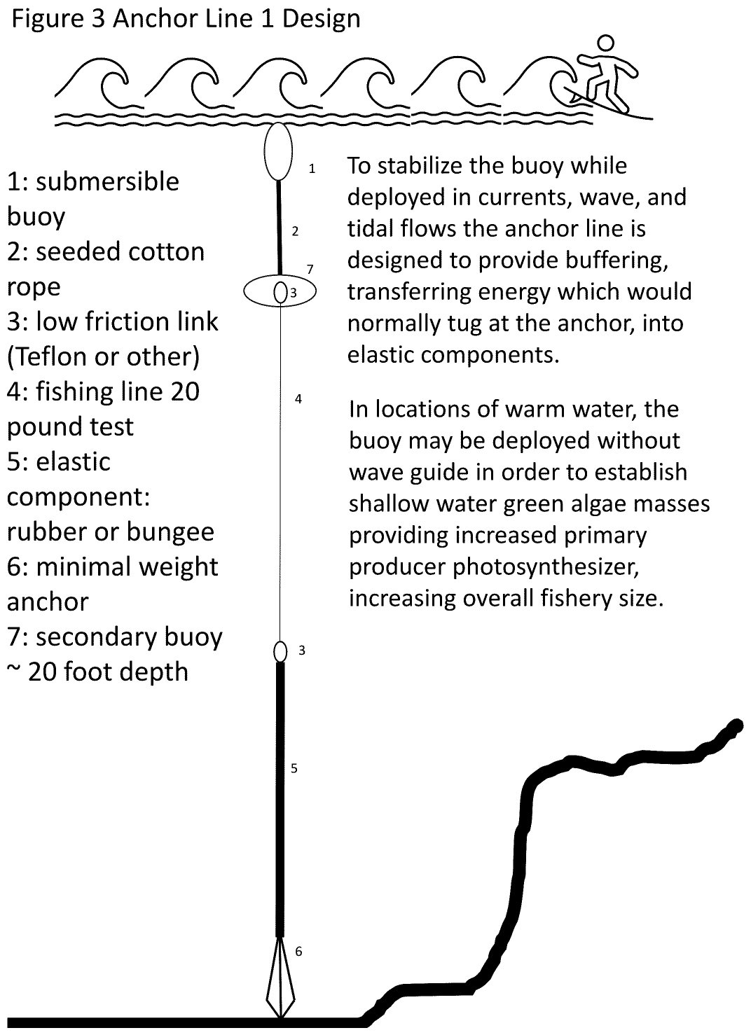

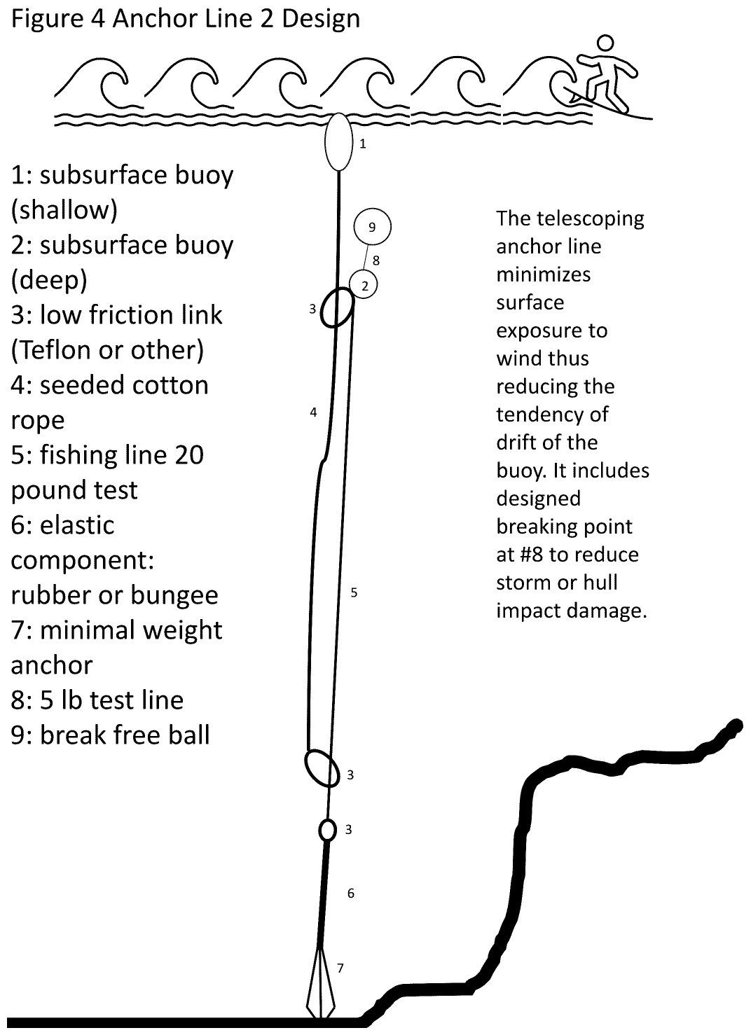

FIG. 1 shows a view of the Algal Wave Guide. In the embodiment the Algal Wave Guide includes the buoy 1 which may be inflatable, molded polystyrene, or other materials based upon the desire for lifecycle extension, cost, portability, ecologically sound disposability, or durability (including UV frequencies). The shape of the buoy is toroidal. However, this does not preclude a change in shape for any of the reasons listed previously in this paragraph. The lens 2 is made of clear glass which may be modified in chemical composition. The lens may also use Fresnel design or be made of plastic. The straps 3 provide points of attachment for essential components such as the anchor line or lens harness. Later iterations may dispense with the straps and harness. The lens harness provides the support to maintain the lens in position within the buoy and proximate to the upper terminus of fiber, upon completion of an integrated design using factory made to order component the harness may become superfluous.

The fiberoptic line 5 is secured to the lens via a threaded nut structure which provides the tension and grip to maintain position of the fiber strand or strands. The anchor strap leads 6 connect from the straps to the primary anchor line facilitating a balance of force between the tug of currents and maintaining the orientation of the lens skyward. The primary anchor line 7 connects the anchor to the anchor strap attachments providing securement for the growth of the stationary located macroalgae. Macroalgae must maintain a relative fixed position in order to conduct metabolic activities which are dependent upon currents and flow of nutrients. The anchor line connection is a solid attachment for the line connected to the anchoring stone. The emitted light 9 is the modification to the maritime environment which will facilitate the expansion of carbon sequestering kelp forests. The light is natural broad spectrum visible wavelengths which are optimal for photosynthesis. In fact macroalgae include additional photosynthetic pigments beyond chlorophyll meaning they are capable of metabolism using a broader range of natural light than terrestrial plant life. Potentially, UV filtration may be introduced to the fiber in order to prolong the lifespan of the fiber and accelerate growth of the Kelp. The lens support circle is part of the lens support harness which provides the securement necessary to maintain the lens skyward. This component may be dispensed with in later designs.

The anchor maintains the position of the Algal Wave Guide and the orientation of buoy and lens skyward, it also may be seeded and designed with a density specific to the seafloor substrate allowing the extension of the kelp forests not only to greater depths but also to differing substrates than those required by Macroalgae (ie. Expansion of the environment from merely stony substrates to sand and mud substrates which are incompatible with macroalgae growth). The threaded wingnut 12 secures the fiberoptic cable proximate to the lens at the focal point increasing light transmission. 13. The threaded wingnut line attachment connects to the straps of the buoy. The fiberoptic weight is a fishing sinker attached to the lower portion of the fiberoptic cable to reduce drift given the predominant material for fiber has a density proximate to water and will be prone to drifting at unusable distances from the sporophyte seeded anchor. The spikes 14 are the placed to reduce predation by sea urchin by preventing the urchin to move close enough to the kelp holdfast (the anchor of the kelp to the sea floor) to feed.

FIG. 3 depicts the simplified anchor line design for areas without common maritime traffic or commercial fishing. The tension from the bottom will cause the buoy to descend in stormy weather as the sea rises with lowered barometric pressure. Additionally, given the descent of the inflatable submersible buoy, pressure will increase by approximate 10% reducing the volume of the buoy reducing it's buoyancy and further descending. The secondary buoy at approximately 20 foot depth retains it's positive buoyancy thus providing a recovery site following storms to pull the primary buoy up to surface for reinflation. This buoy anchor line includes the rubberized bungee material at the base to buffer out wave action torque on the anchor as well as fishing line to reduce drag from currents on the anchor. The low friction link may be made of Teflon or other materials with a low coefficient of friction to avoid wear through.

FIG. 4 Anchor line design is for deployment in areas of larger numbers of vessels, by incorporating the sleeve in sleeve design the anchor line provides a breaking point to avoid anchor drag in the event of a collision with watercraft. A collision in this case would lead only to the loss of the buoy and lens rather than the targeted growth kelp. Furthermore, by incorporating multiple sleeve in sleeve lengths mush greater retraction in extremely violent seas is possible. Recovery would be conducted using typical fishfinding sonar.

The Algal Wave Guide is employed in increasingly deep waters proximate to existing Kelp forests in order to leverage existing sporophyte dissemination and seeding. Focusing on the shallowest water beyond the depth of the existing kelp forests reduces the time required for the Algal Wave Guide to provide sufficient light for the sporophyte to grow sufficiently to achieve photosynthetic independence from the Wave Guide. Upon independence from the Wave Guide the system will be transported and reinstalled allowing for a steady expansion that reduces cost in transportation.

The Algal Wave Guide is manufactured using a PMMA capable polymer extruder which is commonly available machinery in order to extrude the fiberoptic cable 5. The lens 2, is made using a mold in kiln model of manufacturing. The buoy 1 is made using a polystyrene injection molding system. The harness is made using nylon or polyethylene fiber.

1. A wave guide comprised of a buoy, lens, fiberoptic cable, and anchor transmitting optical spectrum of light from the aquatic surface to a plurality photosynthetic organism (for growth) at expanded depths in order to increase the biomass of beneficial environments.

2. A biodegradable anchor line, allowing a simple disconnect at the buoy for movement onto the next zone to be extended.

3. An inner tube providing the buoy function to reduce shipping costs and provide impact elasticity. Inner tube shape includes a channel on the exterior horizontal plane for stowing fiberoptic as the kelp grows upward providing continuous illumination movement toward the surface.

4. A modified lens shape in order to slide and click into the buoy eliminating the harness part requirement. The lens shape to include a recess in which the fiberoptic cable is threaded eliminating the fiber harness as well.

5. Wide gauge PMMA fiberoptic cable (ie. 1 sq cm or larger) in order to reduce risk of tangling and speed installation, while also increasing light dissemination.

6. A set of spikes radiating from the holdfast growth point on the anchor in order to prevent predation of the kelp by sea urchins.

7. A wave guide comprised of a buoy, lens, and anchor transmitting optical spectrum of light from the aquatic surface to a plurality photosynthetic organism (for growth) at expanded depths in order to increase the biomass of beneficial environments This differs from claim 1 in that the fiberoptic cable is dispensed with for the purposes of shallow water (depths of 20 feet or less) light dissemination.

8. A sporophyte seeded anchor comprised partially of lighter weight materials in order to prevent the anchor from penetrating muddy or sandy sea floors and elongated to place the sprorophyte growth initiation as close to the surface as possible. Additionally by providing the kelp a healthy holdfast substrate kelp forests may be extended over sandy or muddy seafloors which are incompatible with macroalgae species.
